(19) United States
(12) Patent Application Publication
(10) Pub. No.: US 2019/0310999 A1
(43) Pub. Date: Oct. 10, 2019

(54) A METHOD AND APPARATUS FOR CATALOGUING AN ELECTRONIC DOCUMENT

(71) Applicant: Private Universe SA, Lausanne (CH)

(72) Inventor: Gérard VANACKER, Paris (FR)

(21) Appl. No.: 16/315,494

(22) PCT Filed: Jul. 7, 2017
(86) PCT No.: PCT/IB2017/054089

§ 371 Date: Jan. 4, 2019

(30) Foreign Application Priority Data
Jul. 7, 2016 (IB) PCT/IB2016/054084

(51) Int. Cl. G06F 16/28; G06F 16/93; G06F 16/22

(52) U.S. Cl. CPC G06F 16/287; G06F 16/2246; G06F 16/93

(57) ABSTRACT

A method for cataloguing an electronic document (20) with a graphical user interface, comprising the steps of: displaying a content of the electronic document (20) in a portion (2) of a display (1); displaying at least a part (40A, 41A) of a first hierarchical classification structure (4A) on a first side of said portion (2), at least a part of a second hierarchical classification structure (4B) on a second side of said portion, and at least a part of a third hierarchical classification structure (4C) on a third side of said portion, wherein each of said hierarchical classification structure comprises a plurality of classification levels (40A, 41A; 40B, 41 B; 40C, 41 C), each level comprising a plurality of classification entries (41A1, . . . ), wherein each of said hierarchical classification structure is different from the other said hierarchical classification structures; selecting at least one of said entries (41A1, . . . ) in at least one of said hierarchical classification structures; storing the selected entries (71, 72, 73) in relation to a link (70) to said document in a database (7).

### FIELD OF THE INVENTION

The present invention concerns a document cataloguing method, a document cataloguing apparatus and a computer program product for cataloguing documents.

### DESCRIPTION OF RELATED ART

Cataloguing an electronic document consists in selecting a classification assigned to the electronic document. This classification could comprise folders, labels and/or or metadata assigned to the document, and used to retrieve it later on among other documents in a collection.

Various methods are commonly used for cataloguing electronic documents.

File explorer systems are based on a hierarchy of folders and subfolders. Each document is saved in one of those subfolders. Users can define their own structure of folders, often based on type of documents and contents. For example, one user may want to save all his photos in one folder “photo” and his music in one folder “music”. The subfolder “music” might contains subfolders for “classic”, “jazz”, “rock” and so on. Each user can define his own hierarchy.

This classification system is flexible, but it is sometime difficult to retrieve one specific document in the hierarchy. For example, a user who remember the name of a musician may hesitate whether his music is jazz or rock, and needs to search in both subfolders.

Documents or links to documents are also often saved in databases which offer more possibilities for searching. Each document might be associated with tags and classified along several dimensions. For example, photo database applications are known in which each photo is associated with a mark (for example a number of stars), a geographic location (for example a GPS coordinate), a time, keywords, names of persons on the photo, and so on. A user can then look for all photos having at least three stars, and captured in July 2015 in Japan. Any piece of information along any of the dimensions can thus be used in order to retrieve all the documents that correspond to the criteria.

However, this additional flexibility often makes the cataloguing program more difficult to use. For cataloguing a document, a user needs to select different parameters that define this document, such as keywords or marks. Keywords are usually freely entered by the user and have no hierarchy. Therefore, if a user wants to catalogue a family photo, he may need to enter both keywords “family” and “children”, and all possible variations thereof, in order to retrieve this photo later; the system does not know that “children” is a subclass of family. Many users fail to enter simultaneously both broad tags and narrow tags for similar concepts, so that any attempt to retrieve this document later on is necessarily unsystematic.

Moreover, the classifications and/or metatags attached to each document are often hidden on the graphical user interface, or at least not presented in an easy-to-read way. It is for example common to have all tags attached to a document presented in a single text box, or on a plurality of text boxes on a single side of the document. This interface is not intuitive, and makes classification and understanding of the existing classification difficult.

An example of such a system is described in EP1209589A2, in which the images selected among a plurality of images simultaneously displayed in a window can be classified by selecting an “add label button” on top of the window. Labels assigned to one image are stored as ASCII text strings or as other types of metadata label identifiers. A list of label entries is stored in a database. The user then selects, from a pull-down menu, a metadata category (e.g., “People—who's in the picture”, “Subject—who's in this picture”, “Type—What type of picture is this?” Then, for the se-lected category, they select one or more metadata items from a second pull down menu. For example, if they select “Subject—who's in this picture, the application may display a menu listing” Ken, Susan, Matthew, JoAnn, etc.” and allow them to click on one or more names. When the user selects “Type—what type of picture is this”, the application displays a menu including a number of emotional or aesthetic categories such as “best photos”, “funny photos”, etc.”. well.

This process has several drawbacks. A first problem is that the user needs several selection steps in order to classify one document at a sub-level of the hierarchy. At each level, a new pull-down needs to be displayed. This results in a slow process, especially when a large number of images needs to be classified.

Furthermore, at most one hierarchical level of the hierarchy is displayed at a given instant; the lower levels are hidden. The user thus needs to navigate through many available pull-down menus in order to verify whether a given classification identifier is available and adequate. Using a hierarchy of pull-down menus is especially difficult on touch display, such as tablets or smart phones, where the menu options are selected with one finger.

In addition, many documents classification systems, including most document management software, move the content of the document to be catalogued into a database or into a dedicated folder. It is then difficult or even impossible to retrieve the document without the document management software. Moreover, enough storage space needs to be available for the new database or new folder.

Other documents cataloguing systems rely on a modified file directory system that replaces the existing file directory of the operating system. Users are often used to the conventional filed directory system and are not willing to replace it.

Some documents cataloguing systems are integrated within an application for processing the document. As an example, some photo processing software include a cataloguing module. Those systems are only adapted for processing and cataloguing one single type of documents, such as photos.

Existing cataloguing systems makes inefficient use of processing and user time, since labels are selected over an iterative process through multiple menus, lists or displays.

There is a need for a new method for cataloguing electronic documents, preferably with a graphical user interface, and avoiding those drawbacks.

There is also a need for a method which is more adapted to touch displays where options are selected with one or several fingers.

### BRIEF SUMMARY OF THE INVENTION

According to one aspect, those needs are achieved with a method allowing a user to select a classification assigned to an electronic document with a graphical user interface, comprising the steps of:

storing in a non-transcient memory a plurality of hierarchical classification structures, wherein each of said hierarchical classification structure comprises a plurality of classification levels, wherein each of said classification levels comprises a plurality of classification entries, wherein each of said hierarchical classification structure is different from the other said hierarchical classification structures;

displaying a content of the electronic document in a portion of a display;

displaying at least a part of at least two levels of a first said hierarchical classification structure on a first side of said portion;

simultaneously displaying at least a part of at least two levels of a second said hierarchical classification structure on a second side of said portion;

simultaneously displaying at least a part of at least two levels of a third said hierarchical classification structure on a third side of said portion;

a user selects at least one of said entries in at least one of said hierarchical classification structures;

storing the selected entries in relation to a link to said document in a database.

A non transcient memory is a digital memory used for permanent or semi-permanent storage of data, usually a memory which is not immediately erased after use or switch off.

A hierarchical classification structure is a set of data, such as labels or other metadata, which are hierarchically organised and which are intended to be assigned to electronic documents in order to catalogue those documents and retrieve them later on. In one example, each piece of data is represented by a record with a text string field; the classification structure is stored as a set of such records with hierarchical relationships between them. Alternatively, XML documents or other digital representations could be used for representing each hierarchical classification structure.

Displaying a content of an electronic document is an operation where an electronic document, such as a file or a record in database, is read from a memory, interpreted and/or decoded depending on its type, and represented as an array of pixels on a portion of a display. For example, displaying an image document stored as jpeg file includes reading this document, decoding it with a jpeg decoder, and commanding a processor or graphic card to control a display in order to show the decoded content.

Displaying a part of at least two levels of a hierarchical classification structure is an operation where the hierarchical classification structure is read from a digital memory, and where a processor controls a display so that a plurality of the classification entries, including entries from a plurality of levels, are simultaneously shown on a display.

A structure is said to be displayed on a “side” of the display portion if it is displayed next to this portion, for example adjacent or in close vicinity to the document. Different structures are said to be displayed on different sides of the portion if they are all displayed adjacent or in close vicinity to different borders of the portion, or in different directions from the barycentre of the portion.

Each classification structure is preferably a classification tree, with a single trunk (the root) and a plurality of branches at each lower level. Starting from the trunk, a document is classified by selecting the most appropriate branch at each level; this leads to a lower level, until a finer classification is no more possible based on the available information, or until a leaf node is reached.

Documents may be catalogued at any level of each structure or tree. Some documents may be catalogued at several nodes of a single structure or tree; for example, an image document representing several persons may be catalogued in each of the different nodes corresponding to those different persons.

According to one aspect, the use of a database for storing links to documents associated with selected classification entries allows for a classification system which is entirely independent from the file directory and/or from the programs used for processing the documents.

The use of conventional links to any document in the conventional file directory system allows a cataloguing of any type of electronic document.

Displaying classification structures simultaneously on at least three different sides of the document makes the classification much easier to read, select and change, since there is more space for the classification structure on the display, and since different sides are used for different hierarchical classification structures. Therefore, less steps and less processing time is required for cataloguing an electronic document.

The use of hierarchical classification structures makes the classification much more effective, since a single step of associating a document with one sublevel of the hierarchy (such as “cat” for example) is sufficient for cataloguing this document in all corresponding higher levels of the hierarchy (such as “mammals” and “animals” for example). Therefore, the user does not need to save one document simultaneously in all three categories “cats”, “mammals” and “animals”.

The use of a plurality of dimensions makes the classification more precise, since a single document could be saved in at least three independent classification structures. For example, a document might be saved in a first classification related to a time, such as the date of capture or generation of the document, and with a hierarchy corresponding for example to years, months, days, etc. The same document might be saved in a second classification related to a location, and a hierarchy corresponding for example to countries, regions or cantons, localities, etc. A third hierarchical classification may be applied to the same document, based on the subject of the document. Each of those hierarchical structures might be displayed on one side of the document.

The simultaneous display of several classification structures allows for a faster overview of available classification entries in different dimensions, without any need for opening sub-menus or dialog boxes just to discover which classification entries are available and appropriate. Again, this results in a much faster cataloguing process, requiring less processing time.

The classification entries displayed along sides of the document are dynamically adapted, depending on the available entries and on selections at previous levels of each structure. Such a dynamic selection of classification entries is only possible in a computerized system.

The documents can be catalogued without typing any character, just by selecting an entry on the displayed classification structure. This makes the cataloguing of electronic documents much faster, in particular with tablets, smartphones or other apparatus lacking a keyboard.

It is also easier and faster to filter and retrieve electronic documents, just by selecting one entry on some or all of the classification structures.

A further hierarchical classification structure may be displayed on one side of the document, and correspond to a person or group of persons.

In one embodiment, some levels of each hierarchical structures are predetermined. Those predetermined levels can't be changed by the user; they correspond to the dimension of the structure, i.e., the type of criteria used in each classification structure.

In one embodiment, at least the first level of each said hierarchical classification structure is predetermined.

In one embodiment, all the levels of at least one hierarchical classification structure are defined by the user.

In one embodiment, at least one level of each said hierarchical classification structure may be modified, for example replaced or changed or added or removed, by a user. The user can thus adapt or complete the classification according to his needs.

In one embodiment, each of said classification structure is visually represented on said display as an array or tree.

In one embodiment, each of said classification structure is displayed as a series of lines or columns, each corresponding to one level of said hierarchical structure.

The portion in which the document is displayed may be rectangular.

The height of each of said columns correspond to the height of said portion.

The width of each of said line corresponds to the width of said portion.

The height, respectively the width, of said columns, respectively lines, may be automatically adapted when the height and/or width of said portion is changed.

In one search mode, the selection of one or a plurality of classification entries with the above described interface generates a list of all documents in the database corresponding to those criteria.

In one aspect, the method comprises a step of replacing the file name of said document with a name automatically generated and taking into account each of said selected entries. The selected name is preferably self-explanatory and indicates the classification of the document.

In one aspect, the method comprises a step of creating a legend for said document, depending on each of said selected entries. The legend may be saved as metadata into the file, or as an accompanying file.

Therefore, the step of cataloguing a document by selecting entries in said classification not only creates a link in said database, but also replaces the file name of the document and/or its metadata or legend. This facilitates the search and understanding of the content of the document in a conventional file directory system. According to this aspect, the invention is also related to a file naming and/or file description method, where a user can change the name of documents, or the associated legend, just by selecting classifications and subclassifications displayed on several sides of the document to rename or file.

The step of selecting at least one of said entries in at least of said hierarchical classification structure may be performed manually by the user, by selecting a portion of a screen corresponding to said entry.

The selection may be performed by clicking on this portion and/or by dragging an icon of the document onto that portion, preferably using a finger on a touch display

The step of selecting at least one of said entries in at least one of said hierarchical classification structure may be performed automatically, based on at least one of:
analysis of a geolocalisation tag associated with the document;
semantical analysis of the document and/or of metadata associated with the document;
face recognition.

The document to be catalogued may be an electronic file in an operating system comprising a file directory. The database is distinct from said file directory.

The part of each hierarchical classification structure that is displayed preferably always includes the first hierarchical level of the structure, and one additional level only, the additional level depending on previously selected entries.

The method further comprises a step of displaying a list of documents corresponding to selected entries next to said document in said portion.

The invention is also related to an apparatus for cataloguing an electronic document with a graphical user interface, comprising:

a non-transcient memory for storing a plurality of hierarchical classification structures, wherein each of said hierarchical classification structure comprises a plurality of classification levels, wherein each of said classification levels comprises a plurality of classification entries, wherein each of said hierarchical classification structure is different from the other said hierarchical classification structures;

a display;

a content display module for displaying a content of the electronic document in a portion of the display;

a classification display module for simultaneously displaying at least a part of a first hierarchical classification structure on a first side of said portion, at least a part of a second hierarchical classification structure on a second side of said portion, and at least a part of a third hierarchical classification structure on a third side of said portion;

a selection module for allowing a user to select at least one of said entries in each of said hierarchical classification structure;

a storing module for storing the selected entries in relation to a link to said document in a database.

The invention is furthermore related to a computer program product comprising computer program code executable by a processing system for causing said processing system to perform any of the above mentioned steps.

### BRIEF DESCRIPTION OF THE DRAWINGS

The invention will be better understood with the aid of the description of an embodiment given by way of example and illustrated by the figures, in which:

FIG. 1 shows a view of a display illustrating a document to be classified and four hierarchical classification structures.

FIG. 2 shows a step of selecting an entry on a first classification structure.

FIG. 3 shows a list of documents that appear when a classification entry at a second hierarchical level of the first classification structures has been selected.

FIG. 4 shows a reduced list of documents that appear when a classification entry at a third hierarchical level of the first classification structures has been selected.

FIG. 5 shows a step of selecting an entry on a second level of a second classification structure.

FIG. 6 shows a step of selecting an entry on a third level of the second classification structure.

FIG. 7 shows a step of adding additional, non-hierarchical marks to a document.

FIG. 8 shows a step of adding a date to a document.

FIG. 9 shows a step of selecting an entry on a second level of a third classification structure.

FIG. 10 shows a step of selecting an entry on a second level of a fourth classification structure.

FIG. 11 is a bloc schema of a system according to one aspect of the invention.

### DETAILED DESCRIPTION OF POSSIBLE EMBODIMENTS OF THE INVENTION

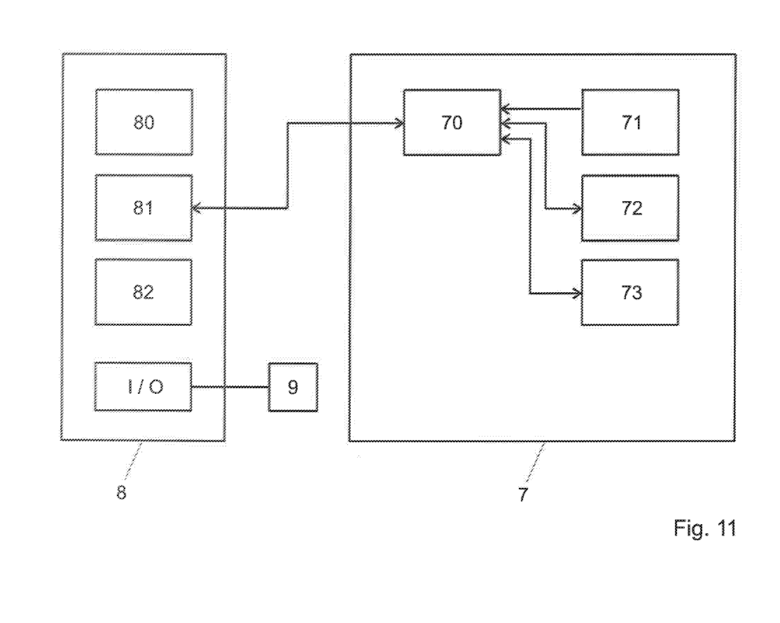

FIG. 11 is a bloc schema of an apparatus according to one aspect of the invention. The apparatus might be a personal computer, a tablet, a smartphone, a camera, etc.

It comprises a processing system 8, such as a personal computer, a tablet, a smartphone etc. The processing system 8 includes a processor 80, possibly a graphic card, and a non transcient memory storing a database management system 81 and a front-end program 82. The database management system 81 may be based on SQL Server, MySQL, Oracle DB, DB2, a list of XML files, etc. and without restrictions. The front-end program 82 may include a browser, an application software, etc. An I/O module connects the processing system 8 with input means, such as a keyboard, a mouse (optional), a touch display, etc., and output means, such as a touch display, a loudspeaker, etc.

The database management system 81 can access a database 7 through a link, such as an ODBC link, or over the Internet. The database 7 may be stored remotely, i.e., in a different equipment or set of equipment than the processing system 8, for example in the cloud. It includes a table 70 for storing links to documents, such as URLs or OLE links for example, and one or a plurality of tables 71, 72, 73 for storing entries associated with each link in one or a plurality of hierarchical classification structures.

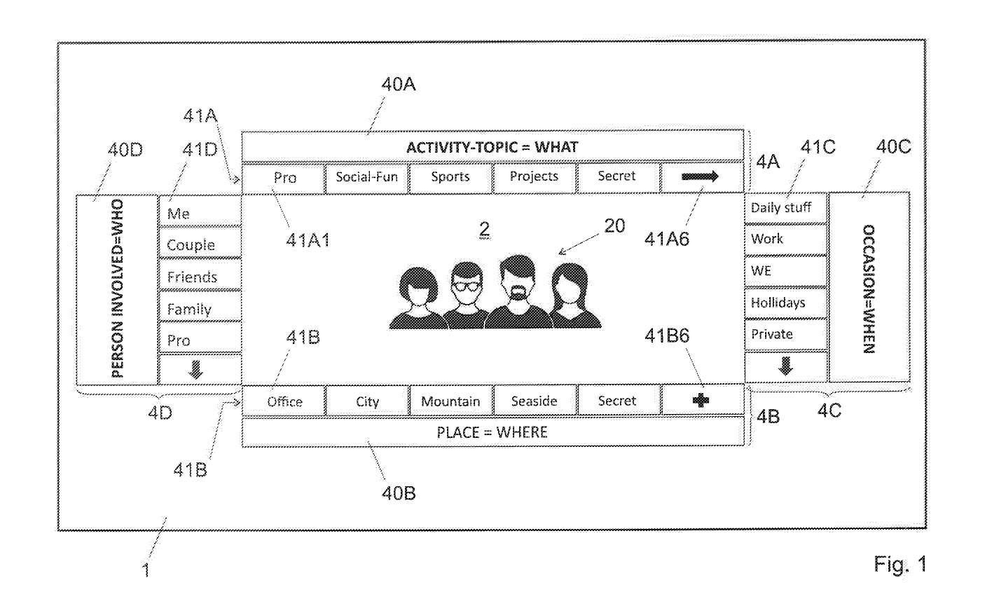

FIG. 1 shows a view of a display 1 that may be generated by the processing system 8 of FIG. 11. This view may be presented directly on the display of the apparatus, or superimposed over already available information.

In the illustrated example, the display shows a document 20, here a photo, in a portion 2 of the display.

The portion 2 is rectangular in this preferred embodiment. Four hierarchical structures 4A to 4D are simultaneously displayed along four sides of the portion 2. Those structures can be permanently presented, or appear and disappear on request, for example simulating drawers that can open or close next to the portion 2.

In the initial position of FIG. 1, the electronic document is not yet categorized, and only the roots of the different hierarchical classification structures are displayed, in an initial position corresponding to the first level. The two hierarchical structures 4A and 4B along the horizontal sides of the portion have the same width than the portion 2. In this example, they each comprise a first line 40A respectively 40B corresponding to a first level of the corresponding classification hierarchy, and a second line 41A respectively 41B corresponding to a second level of the corresponding classification hierarchy. The first line comprises a single classification entry and the second line 41A, respectively 41B, comprises a plurality of classification entries. Both lines have the same width. This width is preferably automatically adapted when the width of the portion 2 is changed. The adaptation may include a change of the width of each individual entry, and/or a change in the number of entries displayed in each line.

In a similar way, the two other hierarchical structures 4C and 4D along the vertical sides of the portion 2 have the same height than the portion 2. In this example, they each comprise a first column 40C respectively 40D corresponding to a first level of the corresponding classification hierarchy, and a second line 41C respectively 41D corresponding to a second level of the corresponding classification hierarchy. The first column comprises a single classification entry and the second column 41C, respectively 41D, comprises a plurality of classification entries. Both columns have the same height. This height is preferably automatically adapted when the height of the portion 2 is changed. The adaptation may include a change of the height of each individual entry, and/or a change in the number of entries displayed in each column.

The box 41A6 includes a scrolling sign, here an arrow pointing to the right direction, allowing the user to scroll horizontally the second line 41A in order to display additional entries. An arrow pointing to the left direction might appear when it is possible to scroll to the left. The box 4166 includes an addition sign, here a + sign, allowing the user to add classification entries to the line 41B. Other equivalent signs may be used. A scrolling sign and/or an addition sign may be added to any of the hierarchical levels of any hierarchical structure. The user can also edit the name of a classification entry, or delete a classification entry, by double-clicking or double tapping on it.

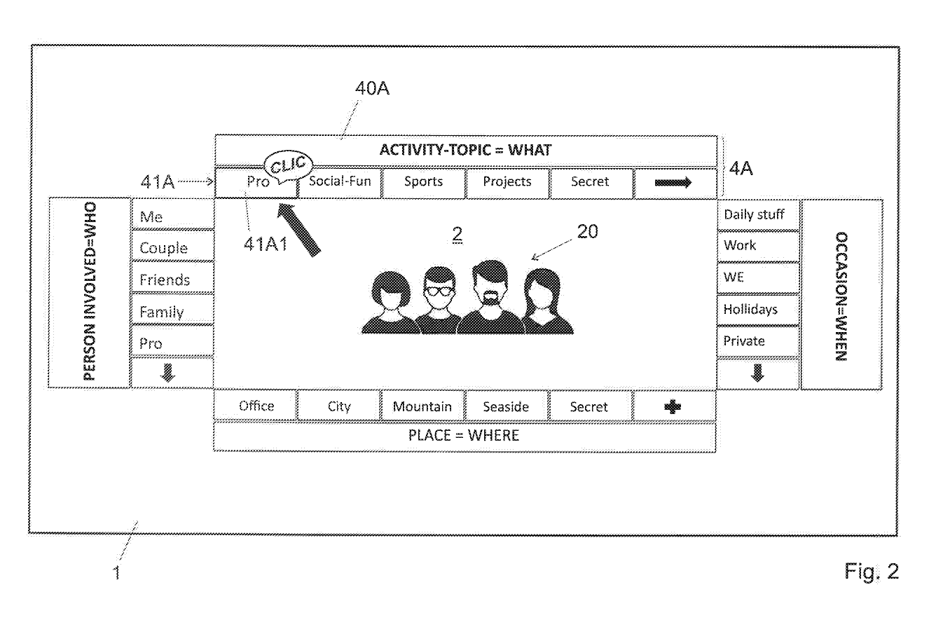

FIG. 2 illustrates a step of selecting the entry 41A1 on the second hierarchical level 41A of the first hierarchical structure 4A. The selection may be performed by clicking on the box corresponding the entry 41A1, or by dragging and dropping the document 20 onto this box (or the box onto the document). The drag and drop is preferably made using a finger on a touch display.

In the illustrated example, the first hierarchical structure indicates a subject or topic of the document 20 (“what”), and the selected entry 41A1 corresponds to “professional”, indicating that the document 20 in portion 2 is related to professional activities. The selection of entry 41A1 automatically assigns this classification entry to the document 20 in portion 2; this classification entry is thus stored in a database in relation with a link to this document.

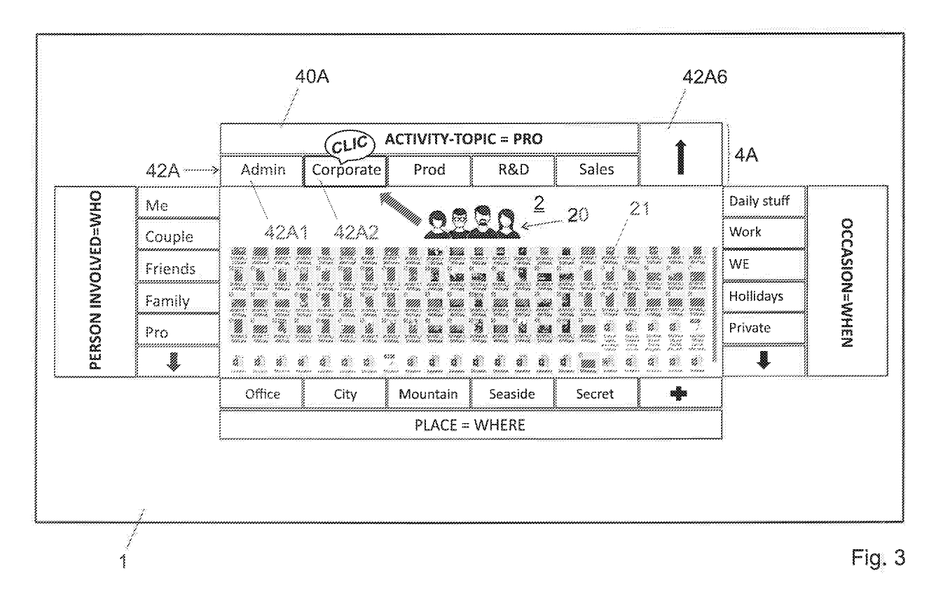

The result of this selection is illustrated on FIG. 3. According to one aspect, the text in the first line 40A is adapted to include the previous selection (“PRO”).

According to another aspect, the second line in the structure 4A is replaced by a line 42A, corresponding to all entries in the hierarchical level (here the third level) immediately below the level (here the level 2) of the previously selected entry, and depending on this entry. In the example, the new line 42A thus includes new selection entries 42A1, 42A2, etc. as possible sub-classifications of 41A1; the text here corresponds to various subactivities in the professional field, such as admin, corporate, production etc. Therefore, each time an entry is selected at hierarchical level i, the second line or column is replaced by entries corresponding to the next level i+1.

The representation of each hierarchical structure may be incomplete, for example if the structure is very deep (many levels) or very wide (many entries at one level). In order to navigate faster and more intuitively, at least one representation simultaneously includes a plurality of classification entries from at least two levels. As an example, the view of hierarchical structure 4A on FIG. 3 includes one classification entry from one upper level (PRO) and several classification entries from a lower level (ADMIN, CORPORATE, PROD, R&D, SALES).

According to a third aspect, the selection of classification entry 41A1 modifies the content displayed in the portion 2 of the display. The displayed size of the document is reduced, and images or icons or a list of all other documents corresponding to the current selection is displayed in this portion. The user can thus rapidly retrieve further documents in the same classification, and open those documents to catalogue or process them.

A navigation symbol, here an arrow, is displayed, here as an entry 42A6, in order to give to the user the possibility to navigate in the first hierarchical structure and, for example, to visit a higher level of this hierarchy.

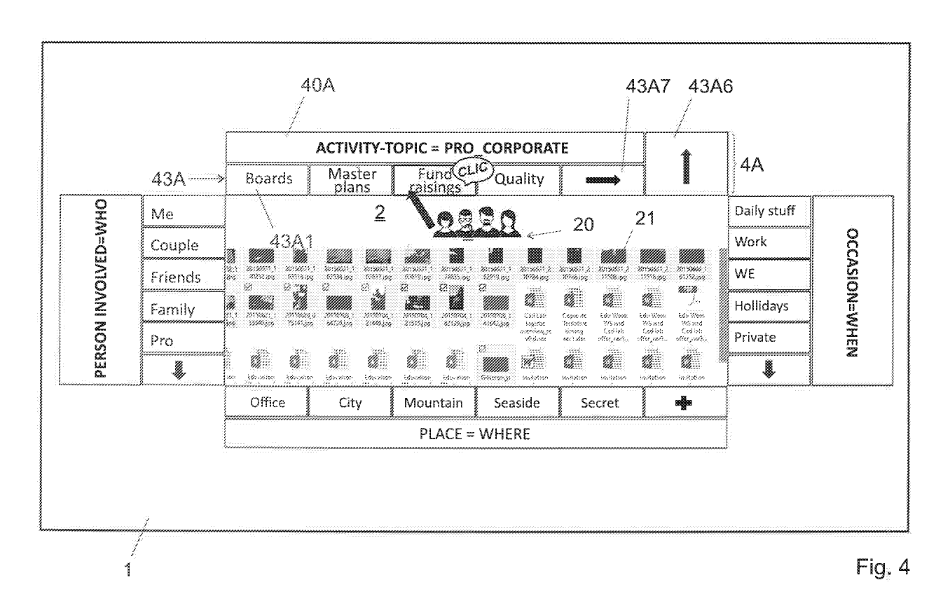

This classification process through the first hierarchical structure may be further refined, as illustrated on FIGS. 3 and 4, by selecting an entry on the third level 42A of the first hierarchical structure. In the illustrated example, the user selects the entry 42A2 (“Corporate”) in this level, thus triggering the display illustrated on FIG. 4. In this example, the text in box 40A is completed with this new level of selection (“PRO Corporate”), and a fourth level of hierarchy is displayed as second line 43A in the structure 4A, allowing a further selection in this fourth level (for example by selecting “fund raising”). The list 21 of documents in portion 2 is further reduced to show only the documents corresponding to the currently selected classification (“Activity=Pro_Corporate”). The document 20 is automatically associated in the database with the selected classification.

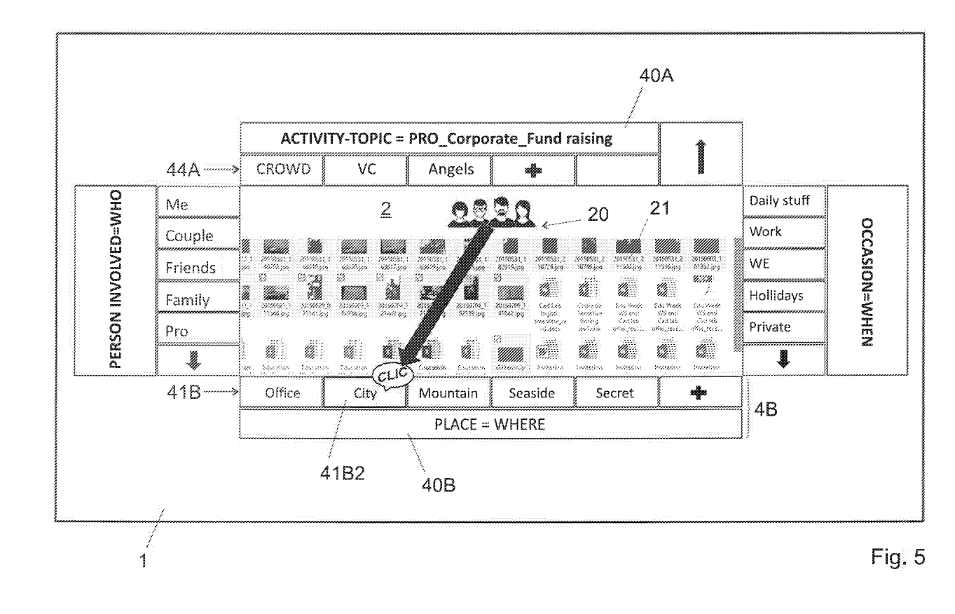

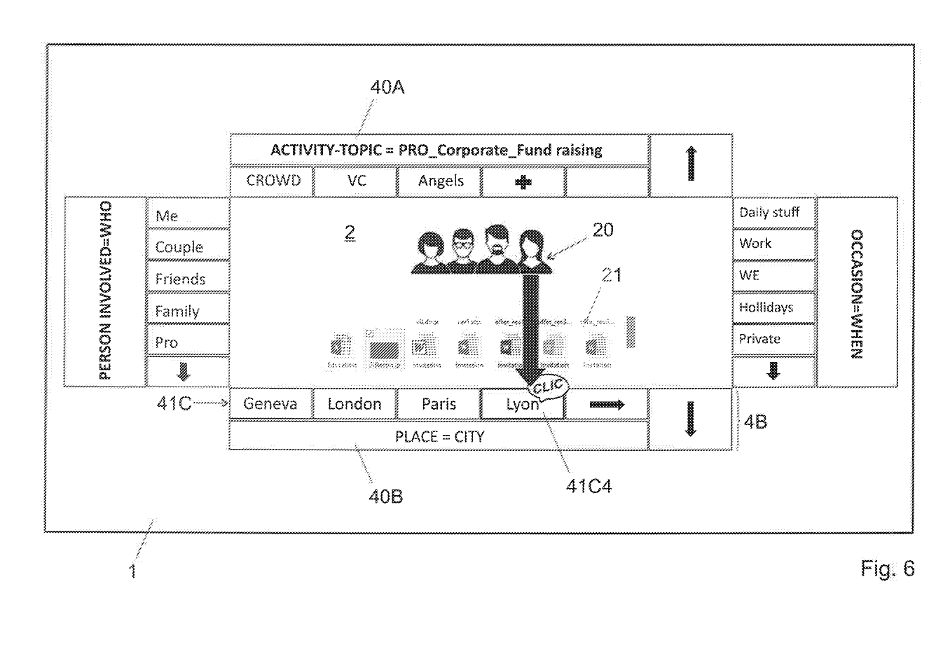

The same document may also be catalogued according to other dimensions, as illustrated on FIGS. 5 to 10. In the example of FIG. 5, the document 20 is associated with the entry 4162 (“City”) in the second level 41B of the second hierarchical structure 40, corresponding here to a location (“Where”).

This selection results in a further reduction in the number of documents in the list 21 displayed in portion 2, and in a replacement of the line 41B by a new line 41 at a third level of the second hierarchical structure, depending on the selection at second level. In the example, the third level 41C comprises a list of cities (Geneva, London, etc.). The document 20 is automatically associated in a database with a city; a further selection of the entry 41C4 may associate this document with the city of Lyon.

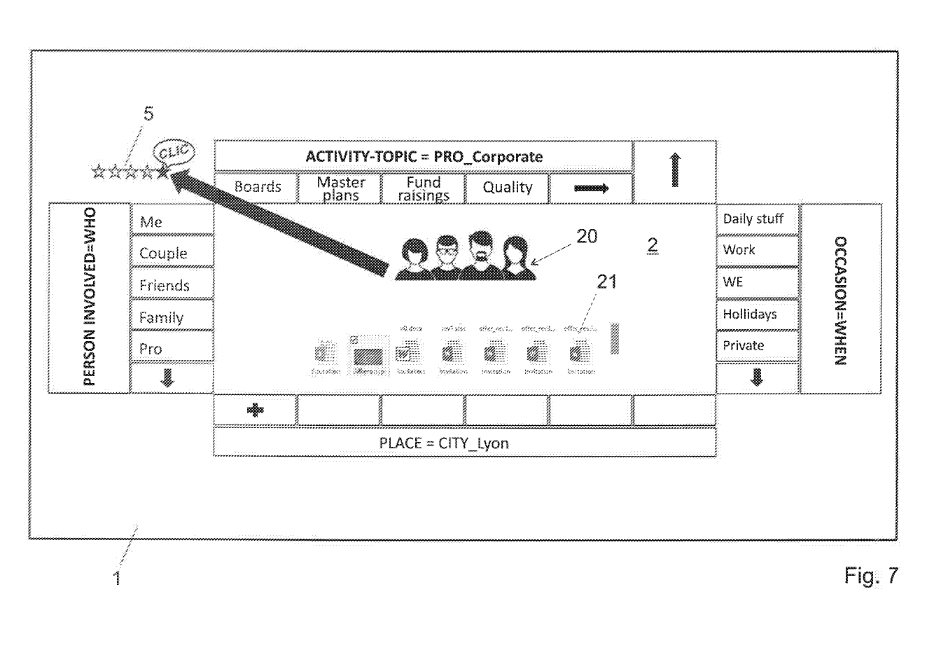

On FIG. 7, the user may further catalogue the selected document 20 in a non-hierarchical dimension, for example by assigning a mark (here four stars) to this document. This classification may be performed by clicking on a selection portion 5 within the portion 2, or outside of this portion as illustrated. For the example, this selection is made while the fourth level of hierarchy 43A is displayed on structure 4A (the user raised within the hierarchy, by selecting a corresponding navigation sign).

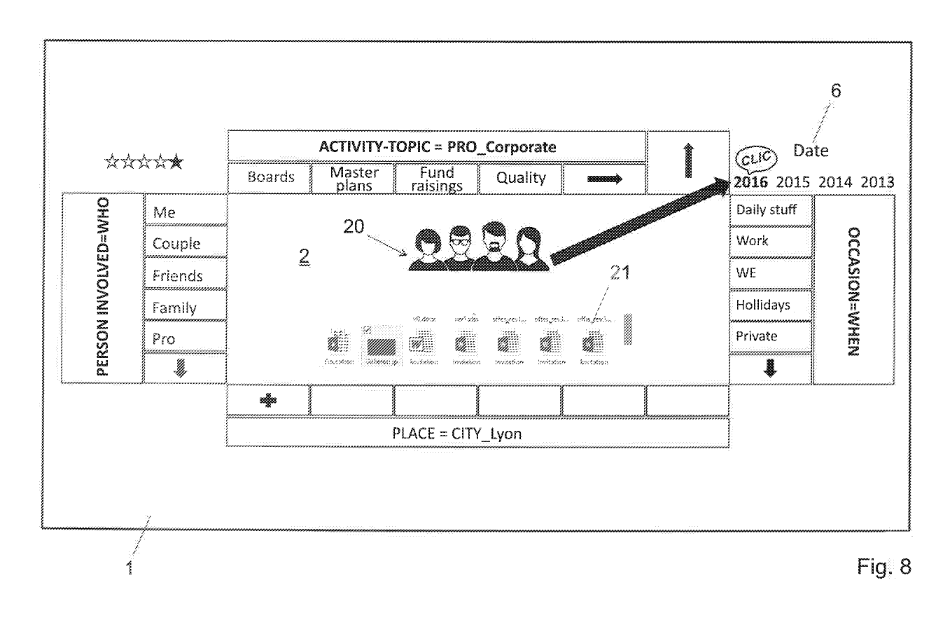

On FIG. 8, the user may further catalogue the selected document 20 in by assigning a date (here 2016) to this document. This classification may be performed by clicking on a date selection portion 6 within the portion 2, or outside of this portion as illustrated.

The metadata might be automatically defined, and changed by the user through the above described interface.

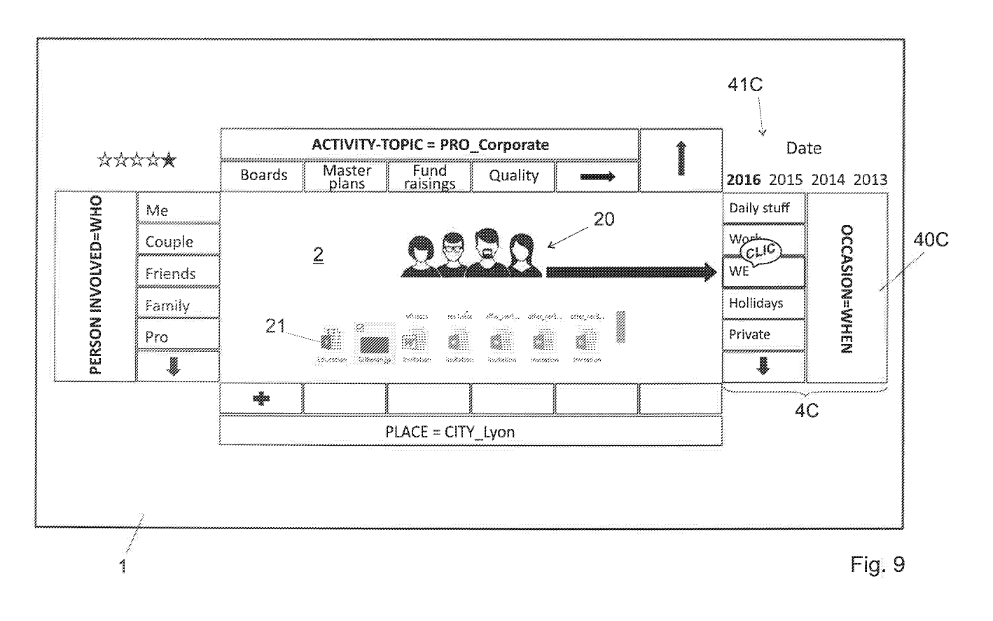

A selection in a third hierarchical structure is illustrated on FIG. 9. In this example, this third structure is displayed along one of the vertical sides of the portion 2, and corresponds to a selection of an event or occasion (“When”). The list of occasions includes in this example “Daily stuff”, “Work”, Week-ends” (as selected), “Holidays”, “Private”, etc.). Again, the selection results in an immediate classification of document 20, in a modification of the displayed hierarchical level, and in a limitation of the list of documents 21 displayed in portion 2.

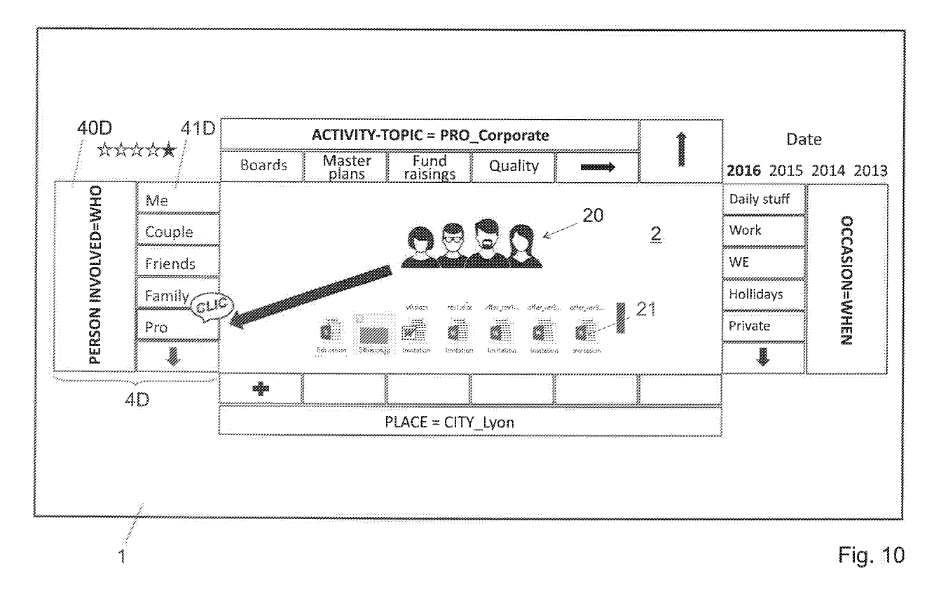

A selection in a fourth, optional hierarchical structure is illustrated on FIG. 10. In this example, this fourth structure is displayed along the other vertical side of the portion 2, and corresponds to a selection of persons or groups of persons (“Who”). The level 1 corresponds to groups or circles such as “Me”, “Couple”, “Family”, etc. Again, the selection results in an immediate classification of document 20, in a modification of the displayed hierarchical level, and in a limitation of the list of documents 21 displayed in portion 2.

The selection in the hierarchical and non-hierarchical structures could be performed in any order; for example, it is not necessary to start with the first hierarchical structure as illustrated.

The above described illustrations illustrate an embodiment in which documents 20 are manually catalogued by the user, by selecting one or several entries in one or several classifications structures 4. In another embodiment, or in combination with this embodiment, some documents may also be catalogued automatically, using a classification module that automatically assigns some classification entries from one or a plurality of the hierarchical classification structures.

For example, a geolocalisation tag or metadata attached to one document may be used for determining an entry in the classification structure 4B (“Where”). The precision of the localisation might determine the hierarchical level of classification that is applied. For example, a localisation at national level, such as the localisation that may be obtained using a national phone code, may be used at the first level; a finer classification may be applied if the document is associated with a more precise localisation, obtained for example with a GPS receiver.

A semantical analysis of the document may also be performed in order to determine an entry in a classification structure, for example in the first (“What”) and/or in the third (“When”) classification structure. The analysis may include an analysis of the title, of the document itself, and/or of metadata associated with the title.

The classification of documents made by a user might be used for profiling the user and determining his interests, and/or for profiling persons or items related to the document.

A computer vision module may further be used for recognising elements of an image in the document 20, and assigning a classification entry based on this recognition. For example, a face recognition program may be used for recognising people in an image, and cataloguing the document in the fourth hierarchical classification structure (“Who”).

This automatic classification may be performed each time the program is used, on all documents in predefined folders which have not been already catalogued. Alternatively, or in addition, the automatic classification may be performed on request, on one or a series of selected documents.

The hierarchical classification structures may be predetermined, as part of the program or database. At least the first level of each classification structure is preferably predetermined. Entries at lower levels may preferably be changed, deleted, added, renamed or replaced by the user, and/or automatically depending on the automatic classification steps previously performed.

As an example, the method may comprise a step of adding a new classification entry and/or replacing a classification entry and/or deleting a classification entry, by editing at least one of the displayed classification structures. The user can carry out all those steps directly from the view of the document, by selecting the classification structures that need to be adapted.

In one aspect, the step of cataloguing a document, by selecting one or a plurality of entries in one or a plurality of the classification structures, triggers a change in the name of the document in the file directory system. For example, the file name associated with the document preferably includes an identification of all selected classification entries. Therefore, a document which has been catalogued with the program of the invention is also easier to retrieve with a conventional file explorer.

In one aspect, the method comprises a step of creating a legend for the document, depending on the selected entries. The legend may be saved as metadata into the file, or as an accompanying file.

The legend may just be a list of selected classification entries. In a preferred embodiment, the method comprises a step of generating a text based on the selected classification entries, and using this text as a legend. As an example, if the following classification entries have been selected for a photo document:

Corporate_Board-Fundraising

Lyon/5s/2016_05_05

Pro_Michel &Catherine&Sarah

5 stars

the following text could be generated and used as a legend:
«This photo is one of the best in the collection. It was taken during a Fund raising event of the Corporate Board that was held in Lyon on May 5, 2017. Work colleagues Michel, Sarah and Catherine are shown on the photo”

This legend may be displayed next or superimposed to the document on the display. It may also be used for retrieving the document with a search engine or database.

1. A method allowing a user to select a classification assigned to an electronic document with a graphical user interface, comprising the steps of:
storing in a non-transcient memory a plurality of hierarchical classification structures, wherein each of said hierarchical classification structure comprises a plurality of classification levels, wherein each of said classification levels comprises a plurality of classification entries, wherein each of said hierarchical classification structure is different from the other said hierarchical classification structures;
displaying a content of the electronic document in a portion of a display;
displaying at least a part of at least two levels of a first said hierarchical classification structure on a first side of said portion;
simultaneously displaying at least a part of at least two levels of a second said hierarchical classification structure on a second side of said portion;
simultaneously displaying at least a part of at least two levels of a third said hierarchical classification structure on a third side of said portion;
having a user selecting at least one of said entries in at least one of said hierarchical classification structures;
storing the selected entries in relation to a link to said document in a database.

2. The method of claim 1, wherein a first hierarchical classification structure corresponds to a subject or activity, a second hierarchical classification structure corresponds to location, and a third hierarchical classification structure corresponds to a time associated with the document.

3. The method of claim 1, wherein one of said classification structures corresponds to a person or group of persons.

4. The method of claim 1, wherein at least the first level of each said hierarchical classification structure is predetermined.

5. The method of claim 1, wherein at least one level of each said hierarchical classification structure is modified by a user.

6. The method of claim 1, wherein each of said classification structure is visually represented on said display as an array or as a tree.

7. The method of claim 1, comprising a step of creating a legend for said document, depending on each of said selected entries, and saving this legend as metadata into the document, or as an accompanying file.

8. The method of one of the claims 1 to 7, comprising a step of replacing the file name of said document (20) with a name automatically generated and taking into account each of said selected entries.

9. The method of claim 1, said step of selecting at least one of said entries in at least of said hierarchical classification structure being performed manually by the user, by selecting a portion of the display corresponding to said entry.

10. The method of claim 1, wherein said part of each hierarchical classification structure includes the first hierarchical level of the structure, and one additional level only, the additional level depending on selected entries.

11. The method of claim 1, further comp rising a step of filtering documents by selecting at least one of said entries.

12. The method of claim 11, further comprising displaying a list of documents corresponding to selected entries.

13. The method of claim 1, said step of selecting at least one of said entries in at least one of said hierarchical classification structure being performed automatically, based on at least one of:
analysis of a geolocalisation tag associated with the document;
semantical analysis of the document and/or of metadata associated with the document; or
face recognition.

14. The method of claim 1, said document being an electronic file in an operating system comprising a tile directory, said database being distinct from said file directory.

15. The method of claim 1, comprising a step of adding a new classification entry and/or replacing a classification entry, by editing at least one of the displayed classification structures.

16. The method of claim 1, said portion being rectangular.

17. An apparatus for cataloguing an electronic document with a graphical user interface, comprising:
a non-transcient memory for storing a plurality of hierarchical classification structures, wherein each of said hierarchical classification structure comprises a plurality of classification levels, wherein each of said classification levels comprises a plurality of classification entries, wherein each of said hierarchical classification structure is different from the other said hierarchical classification structures;
a display;
a content display module for displaying a content of the electronic document in a portion of the display;
a classification display module for simultaneously displaying at least a part of a first hierarchical classification structure on a first side of said portion, at least a part of a second hierarchical classification structure on a second side of said portion, and at least a part of a third hierarchical classification structure on a third side of said portion;
a selection module for allowing a user to select at least one of said entries in each of said hierarchical classification structure;
a storing module for storing the selected entries in relation to a link to said document in a database.

18. A computer program product comprising computer program code executable by a processing system for causing said processing system to perform the steps of claim 1.
